(19) United States
(12) Patent Application Publication
(10) Pub. No.: US 2019/0043530 A1
(43) Pub. Date: Feb. 7, 2019

(54) NON-TRANSITORY COMPUTER-READABLE STORAGE MEDIUM, VOICE SECTION DETERMINATION METHOD, AND VOICE SECTION DETERMINATION APPARATUS

(71) Applicant: FUJITSU LIMITED, Kawasaki-shi (JP)

(72) Inventors: Masanao SUZUKI, Yokohama (JP); Nobuyuki WASHIO, Akashi (JP); Chisato Shioda, Kawasaki (JP)

(73) Assignee: FUJITSU LIMITED, Kawasaki-shi (JP)

(21) Appl. No.: 16/055,312

(22) Filed: Aug. 6, 2018

(30) Foreign Application Priority Data
Aug. 7, 2017 (JP) 2017-152393

(51) Int. Cl. G10L 25/84; G10L 15/20; G10L 25/90; G10L 21/0232

(52) U.S. Cl. CPC G10L 25/84; G10L 21/0232; G10L 25/90; G10L 15/20

(57) ABSTRACT

A voice section determination method including determining, for each of a plurality of sound frames, whether each of the plurality of sound frames corresponds to an utterance section, calculating a background noise for a target sound frame in the plurality of sound frames based on the plurality of sound frames prior to the target sound frame, the plurality of sound frames being included in a silence section, calculating a signal-to-noise ratio by using the calculated background noise, determining which does the target sound frame correspond to a first sound section of a first sound, or a second sound section of a second sound, the second sound being generated by transforming the first sound, and when the target sound frame is determined to correspond to the first sound section, determining whether the target sound frame corresponds to a voice section based on a pitch gain.

### CROSS-REFERENCE TO RELATED APPLICATION

This application is based upon and claims the benefit of priority of the prior Japanese Patent Application No. 2017-152393, filed on Aug. 7, 2017, the entire contents of which are incorporated herein by reference.

### FIELD

The embodiment discussed herein is related to a non-transitory computer-readable storage medium, a voice section determination method, and a voice section determination apparatus.

### BACKGROUND

There is a technology in which it is determined that an acoustic signal corresponds to a sound section or a silence section and the acoustic signal corresponds to an utterance section in a case where a pitch gain of the acoustic signal corresponding to a section determined to be the sound section exceeds a predetermined value. In this technology, background noise is estimated based on an acoustic signal corresponding to a silent section of a section other than a non-utterance section. Then, by calculating a signal-to-noise ratio based on the estimated background noise and determining whether or not the signal-to-noise ratio exceeds the predetermined value, it is determined whether the acoustic signal corresponds to the sound section or the silent section.

In a case where this technology is applied to a voice translation system that detects and translates the presence of utterance, a synthesized voice indicating a translation result of utterance of a user input from a microphone (hereinafter, referred to as microphone), is output from a speaker, and the synthesized voice is input from the microphone. The synthesized voice indicating the translation result of the synthesized voice input from the microphone is output from the speaker, and the synthesized voice is input from the microphone. Translation of the synthesized voice which does not have to be translated is repeated. In this technology, it is determined that the synthesized voice indicating the translation result is also utterance.

In order to solve this problem, there is a technology for stopping detection of the utterance section while the voice translation system is outputting the synthesized voice.

Japanese Laid-open Patent Publication No. 11-133997 is an example of the related art.

Uemura Yukio, “Air Stream, Air Pressure and Articulatory Phonetics”, Humanities 6, pp. 247-291, 2007 is another example of the related art.

### SUMMARY

According to an aspect of the invention, a non-transitory computer-readable storage medium storing a program that causes a computer to execute a process, the process including determining, for each of a plurality of sound frames generated by dividing a sound signal data, whether each of the plurality of sound frames corresponds to an utterance section, calculating a background noise for a target sound frame in the plurality of sound frames based on the plurality of sound frames prior to the target sound frame, the plurality of sound frames being included in a silence section that is not determined to be the utterance section, calculating a signal-to-noise ratio by using the calculated background noise, determining which does the target sound frame correspond to a first sound section of a first sound, or a second sound section of a second sound, the second sound being generated by transforming the first sound, and when the target sound frame is determined to correspond to the first sound section, determining whether the target sound frame corresponds to a utterance section based on a pitch gain indicating a strength of a periodicity of a sound signal of the target frame.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an utterance determination apparatus according to an embodiment;

FIG. 2 is a block diagram illustrating an example of a voice translation system according to the embodiment;

FIG. 3 is a block diagram illustrating an example of a signal-to-noise ratio calculation unit according to the embodiment;

FIG. 4 is a block diagram illustrating an example of an utterance determination unit according to the embodiment;

FIG. 5 is a graph for explaining detection of the utterance section;

FIG. 6 is a graph for explaining a pitch gain threshold used for the detection of the voice section;

FIG. 7 is a block diagram illustrating an example of a hardware configuration of the voice translation system according to the embodiment;

FIG. 8 is a flowchart indicating an example of a flow of an utterance determination process according to the embodiment;

FIG. 9 is a block diagram for explaining a related technology;

FIG. 10 is a graph for explaining a related technology;

FIG. 11 is a graph for explaining a related technology;

FIG. 12A is a diagram for explaining a related technology;

FIG. 12B is a diagram for explaining the related technology; and

FIG. 13 is a diagram for explaining comparison between the present embodiment and a related technology.

### DESCRIPTION OF EMBODIMENT

However, in a case where stopping detection of an utterance section while a voice translation system is outputting a synthesized voice, even if the detection of the utterance section is restarted after output of the synthesized voice is ended, there is a case where the utterance of a user is appropriately not determined. That is because there is a high possibility that there is an error between actual background noise and estimated background noise at a time when detection of the utterance section is restarted because there is no estimation of the background noise while the detection of the utterance section is stopped.

In one aspect, it is aimed to appropriately determine the utterance of user when the detection of the utterance section is restarted even when the detection of the utterance section is stopped while the synthesized voice is being output from the speaker.

Hereinafter, an example of an embodiment will be described in detail with reference to the drawings.

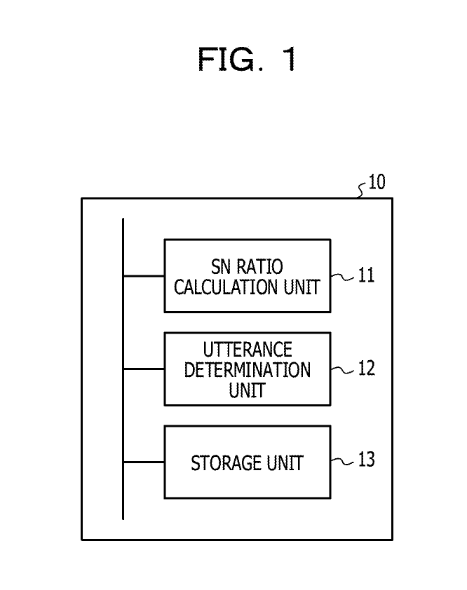

FIG. 1 exemplifies the main functions of the utterance determination apparatus 10.

The utterance determination apparatus 10 includes a signal-to-noise ratio calculation unit 11 (hereinafter, referred to as “SN ratio calculation unit 11”), an utterance determination unit 12, and a storage unit 13. The SN ratio calculation unit 11 calculates a signal-to-noise ratio (hereinafter, referred to as “SN ratio”) with respect to a determination target frame among a plurality of frames including each of divided signals of a predetermined length in which an acoustic signal is divided into a plurality of signals. The SN ratio of the determination target frame is calculated by the background noise estimated by using a divided signal of a frame positioned before a position of the determination target frame and power of the determination target frame. For example, a time length of one frame may be 10 msec to 20 msec.

The utterance determination unit 12 determines that the determination target frame corresponds to a sound section based on magnitude of the calculated SN ratio, and determines whether or not there is a frame in which the determination target frame corresponds to the utterance section in a case where the determination target frame corresponds to a non-synthesized voice section. Whether or not the determination target frame corresponds to the utterance section is performed based on the magnitude of a pitch gain indicating the strength of the periodicity of the divided signal of the determination target frame. The utterance section is a section during which a user utters.

The utterance determination apparatus 10 estimates the background noise based on the divided signal of a frame corresponding to a silence section of a synthesized voice section and the divided signal of a frame corresponding to the silence section of the non-synthesized voice section. That is, in the present embodiment, in a case where it corresponds to the silence section of the non-synthesized voice section, the background noise is estimated based on the divided signal of this frame. Furthermore, in the present embodiment, although it is determined that a frame corresponding to the synthesized voice section is a frame corresponding to a non-utterance section, even in a case where the frame corresponds to the silence section of the synthesized voice section, the background noise is estimated based on the divided signal of the frame. For example, the synthesized voice is voice synthesized by a voice translation apparatus which will be described below, and the non-synthesized voice is voice other than the synthesized voice such as voice by the utterance of users.

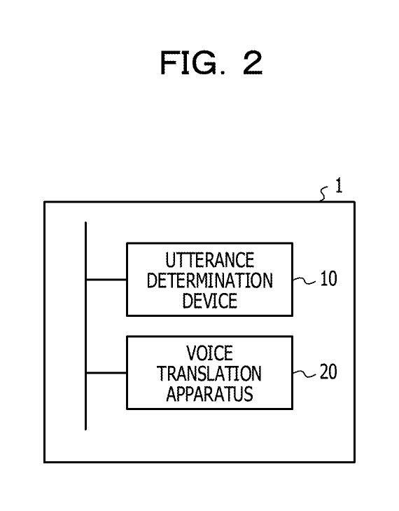

FIG. 2 exemplifies the main function of the voice translation system 1. The voice translation system 1 includes the utterance determination apparatus 10 and a voice translation apparatus 20. The voice translation apparatus 20 receives the divided signal of a frame in which it is determined that the utterance determination apparatus 10 corresponding to the utterance section, recognizes utterance content by using the divided signal, translates the recognized result to language different from original language, and outputs the translated result as voice.

The utterance determination apparatus 10 is not limited to being mounted on the voice translation system 1. The utterance determination apparatus 10 can be mounted on various apparatuses employing a user interface that uses, for example, voice recognition, a navigation system, a mobile phone, a computer, or the like.

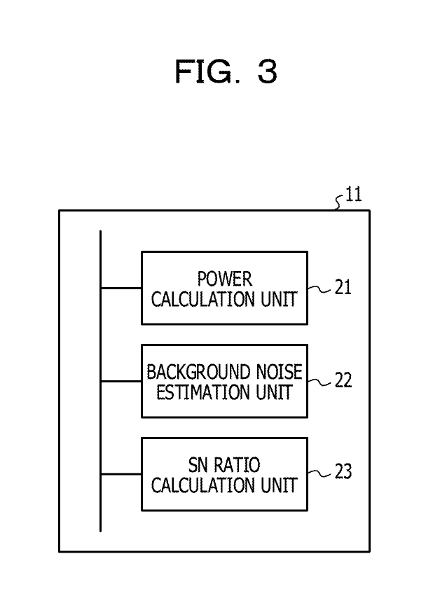

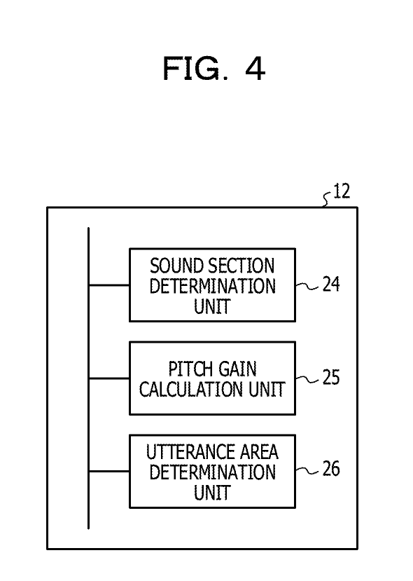

FIG. 3 exemplifies the main function of an SN ratio calculation unit 11. The SN ratio calculation unit 11 includes a power calculation unit 21, a background noise estimation unit 22, and a signal-to-noise ratio calculation unit 23 (hereinafter, referred to as “SN ratio calculation unit” 23). FIG. 4 illustrates the main function of the utterance determination unit 12. The utterance determination unit 12 includes a sound section determination unit 24, a pitch gain calculation unit 25, and an utterance section determination unit 26.

The power calculation unit 21 calculates power of the divided signal (hereinafter, referred to as “acoustic signal”) of the determination target frame. For example, power Spow (k) of the acoustic signal of the determination target frame that is the k-th frame (k is natural number) is calculated by Equation (1).

$$Spow ( k ) = {\sum }_{n = 0}^{N - 1} {{s}_{k} ( n )}^{2} \qquad ( 1 )$$

sk (n) is an amplitude value of the acoustic signal at the n-th sampling point of the k-th frame. N is the number of sampling points included in one frame.

The power calculation unit 21 may calculate power for each frequency bandwidth. In this case, the power calculation unit 21 converts a time domain acoustic signal into a frequency domain spectrum signal by using time frequency conversion. For example, the time frequency conversion may be fast fourier transform (FFT). The power calculation unit 21 calculates the sum of squares of the spectrum signals included in the frequency bandwidth for each frequency bandwidth as the power of the frequency band.

In a case where the determination target frame corresponds to the silence section, the background noise estimation unit 22 estimates the background noise in the acoustic signal of the determination target frame. Determination as to whether or not the determination target frame is the silence section will be described below. In a case where the determination target frame corresponds to the synthesized voice section, it is determined that the determination target frame corresponds to the non-utterance section, as will be described below. However, in the present embodiment, even if the determination target frame is the synthesized voice, in a case where the determination target frame corresponds to the silence section, the background noise of the acoustic signal in the determination target frame is estimated.

Even if the synthesized voice section is the silence section, by estimating the background noise, an error from the actual background noise changing with time is reduced. Meanwhile, when the background noise is estimated in the sound section of the synthesized voice section, since the error from the actual background noise is rather large, the background noise is not estimated in the sound section of the synthesized voice section.

For example, the background noise Noise (k) is calculated by Equation (2) using the background noise Noise (k−1) estimated in a frame immediately before the k−1-th frame, that is, the determination target frame and the k-th frame, that is, the power of the determination target frame Spow (k). The background noise is used to calculate the SN ratio for determining whether or not the determination target frame is sound.

Noise(k)=β·Noise(k−1)+(1−β)·Spow(k) (2)

β is a forgetting factor, for example, may be 0.9. That is, the background noise is calculated by using the background noise estimated in a frame immediately before the determination target frame and the power of the determination target frame, but the background noise of the frame immediately before that is calculated by using the background noise of the frame immediately before that. Therefore, the background noise of the determination target frame is estimated by using the frame positioned before the position of the acoustic signal of the determination target frame.

In a case where the determination target frame corresponds to the sound section, the background noise estimation unit 22 does not estimate the background noise of the determination target frame. In this case, the same background noise as the previous frame as the background noise of the determination target frame is set.

The SN ratio calculation unit 23 calculates the SN ratio of the determination target frame. For example, the SN ratio calculation unit 23 calculates the SN ratio of the determination target frame SNR (k) by Equation (3).

$$SNR ( k ) = 10 \cdot {log}_{10} \frac{Spow ( k )}{Noise ( k - 1 )} \qquad ( 3 )$$

That is, the SN ratio of the determination target frame is calculated by using the background noise estimated in the previous frame of the determination target frame. Until the estimation of the background noise is sufficiently performed, that is, a predetermined value may be used as background noise until the background noise is estimated by using a sufficient number of frames.

The sound section determination unit 24 determines whether or not the determination target frame corresponds to the sound section based on the SN ratio of the determination target frame. The sound section is a section in which it is estimated that the acoustic signal other than the background noise is included in the acoustic signal in the section. Since the utterance section is included in the sound section, by performing the detection of the utterance section in the sound section, it is possible to improve the detection accuracy of the utterance section.

In order to determine whether or not the determination target frame corresponds to the sound section, the SN ratio of the determination target frame is compared with a sound determination threshold Thsnr. For example, the sound determination threshold Thsnr may be two or three. In a case where the SN ratio is equal to or greater than the sound determination threshold Thsnr, the sound section determination unit 24 determines that the determination target frame corresponds to the sound section, and in a case where the SN ratio is less than the sound determination threshold Thsnr, it is determined that the determination target frame corresponds to the silence section.

The sound section determination unit 24 may determine that the determination target frame after the frame in which the SN ratio is equal to or greater than the sound determination threshold Thsnr is continued for a predetermined period (for example, one second) corresponds to the sound section. In addition, the sound section determination unit 24 may determine that the determination target frame after the frame in which the SN ratio is less than the sound determination threshold Thsnr, is continued for a predetermined period corresponds to the silence section after the presence of the frame in which the SN ratio is equal to or greater than the sound determination threshold Thsnr.

The sound section determination unit 24 may determine that the determination target frame corresponds to the sound section based on the power of the determination target frame. In this case, if the power of the determination target frame is equal to or greater than a predetermined threshold, the sound section determination unit 24 may determine that the determination target frame corresponds to the sound section, and if the power of the determination target frame is less than the predetermined threshold, the sound section determination unit 24 may determine that the determination target frame corresponds to the silence section. As the background noise estimated in the determination target frame, the predetermined threshold may be set to be higher.

The sound section determination unit 24 transmits information indicating the determined result as to whether or not the determination target frame corresponds to the sound section to the background noise estimation unit 22 and the pitch gain calculation unit 25. For example, the information indicating the determined result as to whether or not it corresponds to the sound section, may be a sound flag which is “1” in a case where it corresponds to the sound section, and which is “0” in a case where it corresponds to the silence section.

The background noise estimation unit 22 and the pitch gain calculation unit 25 determine whether or not the determination target frame corresponds to the sound section based on the sound flag. For example, the sound flag is stored in the storage unit 13.

In a case where the sound section determination unit 24 determines that the determination target frame corresponds to the silence section, after the utterance section determination unit 26 detects a frame corresponding to the utterance section, before detecting the frame corresponding to the non-utterance section, it may be determined that the determination target frame is the non-utterance section.

In a case where the determination target frame corresponds to the sound section, the pitch gain calculation unit 25 calculates pitch gain indicating the strength of the periodicity of sound. The pitch gain is also referred to as pitch prediction gain.

In the utterance section, due to the characteristics of human voice, a certain degree of periodicity is recognized in the acoustic signal. Therefore, the utterance section is detected based on the pitch gain indicating the strength of the periodicity of the acoustic signal. By using the pitch gain, the utterance determination apparatus 10 can more accurately detect the utterance section than using the power or the SN ratio that can take a large value other than the human voice.

The pitch gain calculation unit 25 calculates long-term autocorrelation C(d) of the acoustic signal with respect to a delay amount d∈{d_{low}, . . . , d_{high}} by using Equation (4).

$$C ( d ) = {\sum }_{n = 0}^{N - 1} {s}_{k} ( n ) \cdot {s}_{k} ( n - d ) ( d = {d}_{low} , … , {d}_{high} ) \qquad ( 4 )$$

The lower limit d_{low} and the upper limit d_{high} of the delay amount d are set so as to include the delay amount corresponding to 55 to 400 Hz which is the fundamental frequency of human voice. For example, in a case where a sampling rate is 16 k Hz, d_{low}=40 and d_{high}=288 may be satisfied.

That is, the fundamental frequency of 55 Hz is 18 ms (=1/55 Hz), and the fundamental frequency of 400 Hz is 2.5 ms (=1/400 Hz). In a case where the sampling rate is 16 kHz, since the delay of one sample is 62.5 μs (=1/16000), d_{low}=40 (=2.5 ms/62.5 μs) and d_{high}=288 (=18 ms/62.5 μs).

The pitch gain calculation unit 25 calculates the long-term autocorrelation C(d) with respect to each of the delay amounts d included in a range of the delay amount d_{low} to d_{high} and acquires the maximum value C (dₘₐₓ) of the long-term autocorrelation C(d). dₘₐₓ is the delay amount corresponding to the maximum value C (dₘₐₓ) in the long-term autocorrelation C(d), and the delay amount corresponds to a pitch period. The pitch gain calculation unit 25 calculates the pitch gain g_{pitch} by Equation (5).

$${g}_{pitch} = \frac{C ( {d}_{ma x} )}{{\sum }_{n = 0}^{N - 1} {s}_{k} ( n ) \cdot {s}_{k} ( n )} \qquad ( 5 )$$

In a case where the determination target frame corresponds to the sound section, the utterance section determination unit 26 determines whether or not the determination target frame corresponds to the utterance section by comparing the pitch gain g_{pitch} with an utterance section detection threshold. That is, in a case where the non-utterance section during which a user does not utter is continued, the utterance section determination unit 26 determines that the utterance section during which the user utters that the pitch gain g_{pitch} is equal to or greater than the first threshold Th1, is started, that is, that it is the utterance section. Meanwhile, in a case where the utterance section is continued, the utterance section determination unit 26 determines that the utterance section that the pitch gain is less than the second threshold Th2 which is smaller than the first threshold Th1, that is, is the non-utterance section.

When humans utter continuously, expiratory pressure decreases at the end of the sentence and the periodicity of glottis closure weakens. Therefore, in the utterance section, since the pitch gain attenuates toward the end of the utterance section, the second threshold with respect to the pitch gain used for detecting the end of the utterance section is set lower than the first threshold with respect to the pitch gain used for detecting the start of the utterance section.

In the present embodiment, in a case where the previous frame of the determination target frame is not a frame corresponding to the utterance section, the utterance section determination unit 26 compares the first threshold with the pitch gain. Whether or not the previous frame is included in the utterance section is determined by referring an utterance section flag indicating whether or not the previous frame is the utterance section, stored in, for example, the storage unit 13. In a case where the pitch gain is equal to or greater than the first threshold, the utterance section determination unit 26 determines that the determination target frame is the utterance section. The utterance section determination unit 26 sets the utterance section flag to a value (for example, “1”) indicating that it is the utterance section.

In a case where the previous frame of the determination target frame corresponds to the utterance section, the utterance section determination unit 26 compares the second threshold smaller than the first threshold with the pitch gain of the determination target frame. In a case where the pitch gain is less than the second threshold, the utterance section determination unit 26 determines that the utterance section is ended up to the previous frame. The utterance section determination unit 26 sets the utterance section flag to a value (for example, “0”) indicating that it is the non-utterance section.

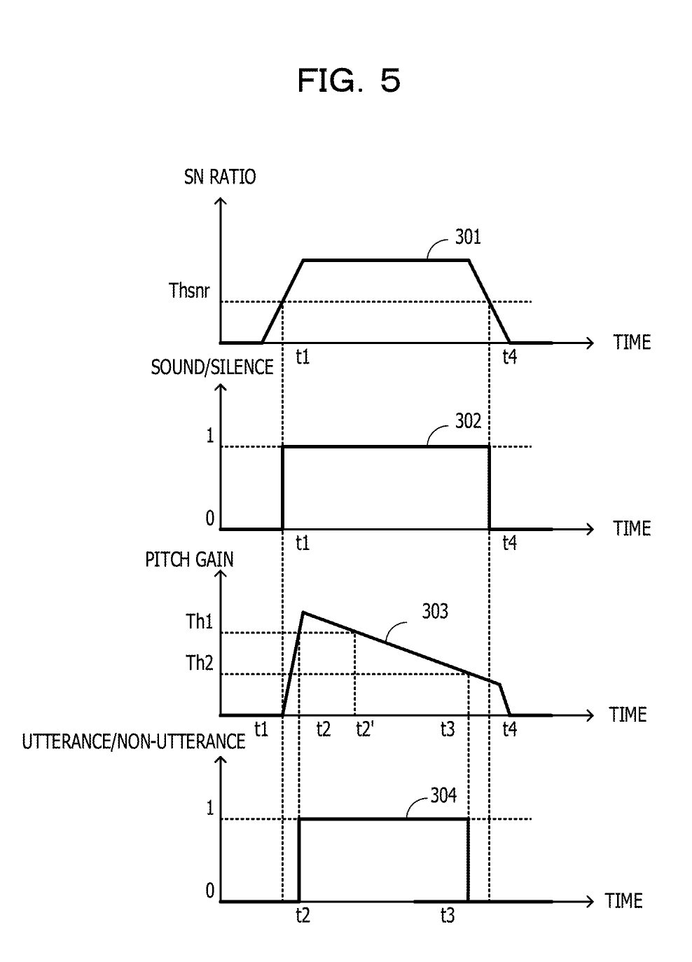

FIG. 5 is a diagram for explaining an overview of an utterance determination process according to the present embodiment. In each flag of FIG. 5, the horizontal axis indicates time. In the uppermost graph, the vertical axis indicates the SN ratio. In the second graph from the top, the vertical axis indicates the determined result of whether it is the sound section or the silence section. In the third graph from the top, the vertical axis indicates the pitch gain. In the bottom graph, the vertical axis indicates the determined result as to whether it is the utterance section.

In the uppermost graph, a line 301 indicates the time change of the SN ratio. In the second graph from the top, a line 302 indicates the determined result as to whether the sound section is the silence section. In an example of FIG. 5, as illustrated by the line 301, the SN ratio is equal to or greater than the sound determination threshold Thsnr at time t1, and the SN ratio is less than the sound determination threshold Thsnr at time t4. As a result, as illustrated by the line 302, it is determined that it is the sound section (“1”) in a section from time t1 to time t4 and it is determined that it is the silence section (“0”) before the time t1 and after the time t4.

In the third graph from the top, the vertical axis of a line 303 indicates the pitch gain. The pitch gain is equal to or greater than the first threshold Th1 at time t2 and the pitch gain is less than the second threshold Th2 at time t3. Therefore, as illustrated by the line 304 of the bottom graph, it is determined that a time from the time t2 to the time t3 is the utterance section (“1”).

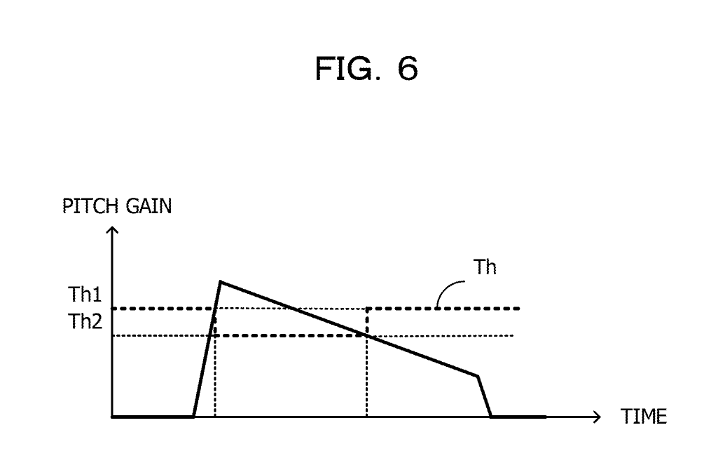

As illustrated by the line 303, the pitch gain attenuates gradually as it reaches the peak after the start of the utterance. Therefore, when it is determined the utterance section is ended at the time t2′ less than the first threshold Th1, a section shorter than the original utterance section is detected as the utterance section. In the present embodiment, as exemplified in FIG. 6, the start of the utterance section is determined by the first threshold Th1, and the end of the utterance section is determined by the second threshold Th2 smaller than the first threshold Th1. That is, by determining that the utterance section is ended at the time t3 at which it is the second threshold Th2 smaller than the first threshold Th1 by changing a threshold, it is possible to appropriately detect the utterance section.

In the present embodiment, it is not limited to using the first threshold and the second threshold value smaller than the first threshold. For example, a single threshold may be used.

The voice translation apparatus 20 receives a detection result of the utterance section from the utterance determination apparatus 10, recognizes the utterance content by using the acoustic signal of the utterance section by using an existing method, translates the recognized result into a language different the original language, and outputs the translated result as voice.

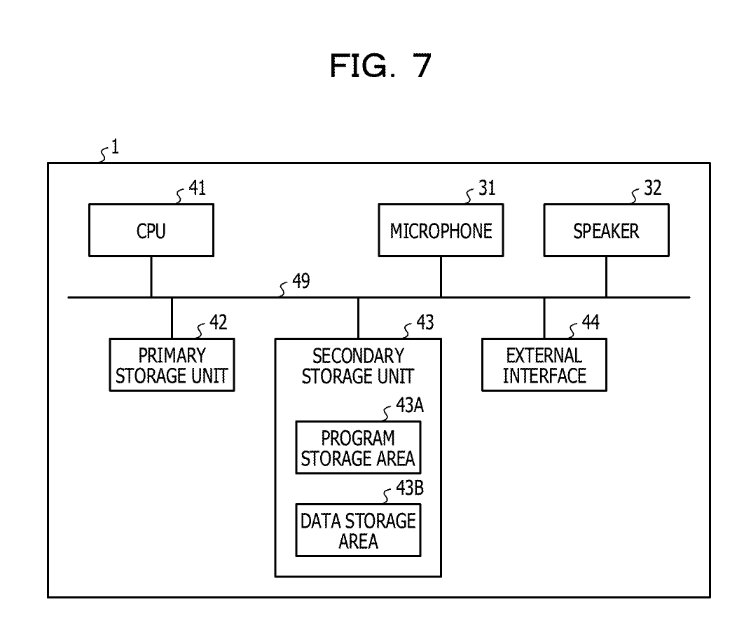

FIG. 7 exemplifies a hardware configuration of the voice translation system 1. The voice translation system 1 includes a central processing unit (CPU) 41 that is an example of a processor of hardware, a primary storage unit 42, the secondary storage unit 43, and an external interface 44. In addition, the voice translation system 1 includes a speaker 32 that is an example of a microphone 31 (hereinafter, referred to as “microphone” 31) or a voice output unit.

The CPU 41, the primary storage unit 42, the secondary storage unit 43, the external interface 44, the microphone 31, and the speaker 32 are connected to each other via a bus 49.

For example, the primary storage unit 42 is a volatile memory such as a random-access memory (RAM). For example, the secondary storage unit 43 includes a non-volatile memory such as a hard disk drive (HDD) or a solid-state drive (SSD), and the volatile memory such as RAM. The secondary storage unit 43 is an example of the storage unit 13 of FIG. 1.

The secondary storage unit 43 includes a program storage area 43A and a data storage area 43B. The program storage area 43A stores a program such as an utterance determination program and the voice translation program. The data storage area 43B stores intermediate data such as the acoustic signal of sound acquired from the microphone 31, the acoustic signal of a language different from the original language translated by using the acoustic signal, and a flag indicating whether or not it is the utterance section.

The CPU 41 reads the utterance determination program from the program storage area 43A, and develops the read program to the primary storage unit 42. The CPU 41 operates as the utterance determination apparatus 10 of FIG. 2, that is, the SN ratio calculation unit 11 and the utterance determination unit 12 of FIG. 1 by executing the utterance determination program.

The CPU 41 reads the voice translation program from the program storage area 43A, and develops the read program to the primary storage unit 42. The CPU 41 operates as the voice translation apparatus 20 of FIG. 2 by executing the voice translation program. A program such as the utterance determination program and the voice translation program may be stored in a non-transitory recording medium such as a digital versatile disc (DVD), read via the recording medium reading apparatus, and developed the read result to the primary storage unit 42.

An external device is connected to the external interface 44 and the external interface 44 controls transmission and reception of various types of information between the external device and the CPU 41. The microphone 31 and the speaker 32 may be connected as the external device via the external interface 44.

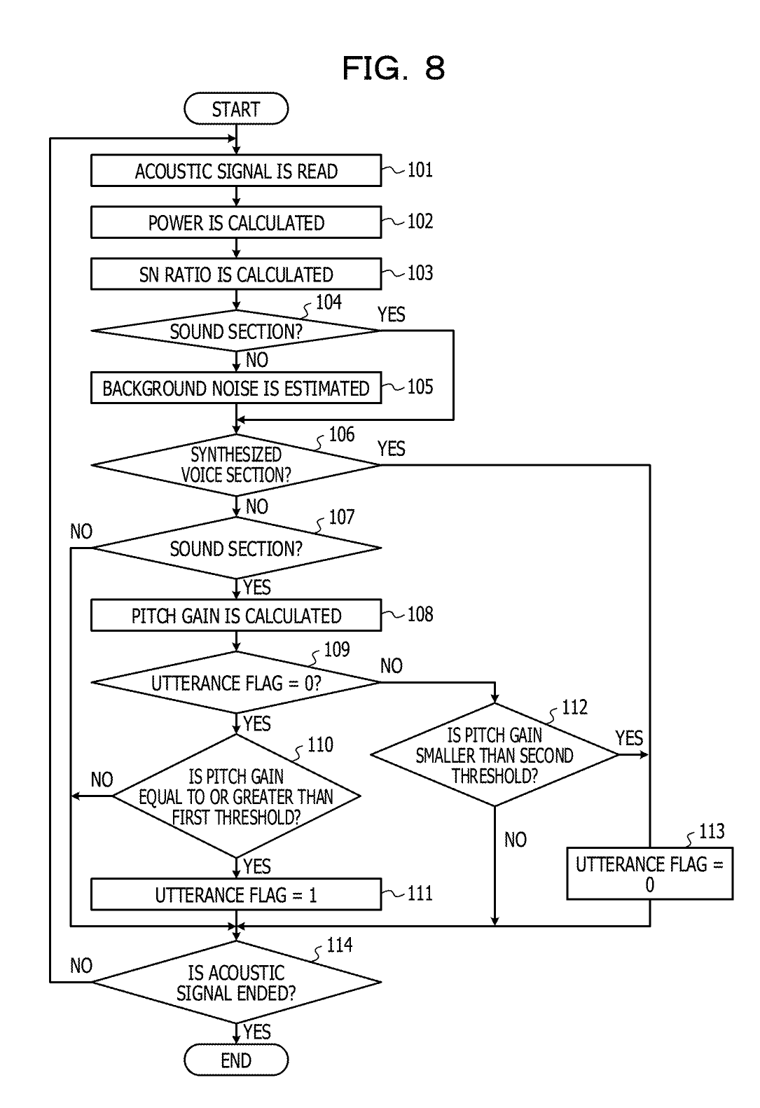

Next, the outline of an operation of the utterance determination apparatus 10 will be described. The outline of the operation of the utterance determination apparatus 10 is exemplified in FIG. 8. For simplicity of description, the description of the above-described process will be omitted. For example, in step 101, when the user turns on the power of the voice translation system 1, the CPU 41 reads one frame of the acoustic signal corresponding to sound acquired by the microphone 31 as the determination target frame.

In step 102, the CPU 41 calculates power by using the acoustic signal of one frame. The CPU 41 calculates the SN ratio by using the calculated power based on the above Equation (3), in step 103.

In step 104, the CPU 41 compares the calculated SN ratio with the sound determination threshold Thsnr, and determines whether or not the determination target frame corresponds to the sound section. In a case where the determination in step 104 is negative because the SN ratio is less than the sound determination threshold Thsnr, the CPU 41 proceeds to step 106 after the background noise is estimated by using the acoustic signal of the determination target frame, in step 105. In a case where the determination in step 104 is positive, the CPU 41 proceeds to step 106.

That is, in the present embodiment, as will be described below, although it is determined that the determination target frame corresponding to the synthesized voice section is the non-utterance section, even if the determination target frame corresponds to the synthesized voice section, in a case where it corresponds to the silence section, the background noise is estimated.

In step 106, the CPU 41 determines whether or not the determination target frame corresponds to the synthesized voice section. In the present embodiment, in a case where the synthesized voice is output by the speaker 32, the voice translation system 1 sets a synthesized voice flag to “1”, and in a case where the synthesized voice is not output by the speaker 32, the voice translation system 1 sets the synthesized voice flag to “0”.

For example, the synthesized voice flag is stored in a data storage area 43B of the secondary storage unit 43. Therefore, in a case where the synthesized voice flag is “1”, the CPU 41 determines that the determination target frame corresponds to the synthesized voice section, and in a case where the synthesized voice flag is “0”, the CPU 41 determines that the determination target frame not corresponds to the synthesized voice section.

In a case where the synthesized voice flag is “0” and the determination in step 106 is negative, the CPU 41 determines whether or not the determination target frame corresponds to the sound section, in step 107. For example, the CPU 41 may use the determined result in step 104, and may determine whether or not the determination target frame corresponds to the sound section similar to step 104.

In a case where the determination in step 107 is positive, that is, in a case where it is the sound section, the CPU 41 calculates the pitch gain of the determination target frame, in step 108. The CPU 41 determines whether or not the previous frame of the determination target frame is the frame corresponding to the utterance section, in step 109.

In the present embodiment, it is assumed that in a case where the frame corresponds to the utterance section, “1” is set to an utterance flag corresponding to the frame, and in a case where the frame corresponds to the non-utterance section, “0” is set to the utterance flag corresponding to the frame. For example, the utterance flag is stored in the data storage area 43B of the secondary storage unit 43. Therefore, in a case where the utterance flag of the previous frame of the determination target frame is “1”, the CPU 41 determines that the previous frame is the frame corresponding to the utterance section. In addition, in a case where the utterance flag of the previous frame is “0”, it is determined that the previous frame is the frame corresponding to the non-utterance section.

In a case where the determination in step 109 is positive, that is, in a case where the utterance flag is “0” and the previous frame corresponds to the non-utterance section, the CPU 41 determines whether or not the pitch gain is equal to or greater than the first threshold Th1, in step 110. In a case where the determination in step 110 is positive, that is, in a case where the pitch gain is equal to or greater than the first threshold Th1, the CPU 41 sets the utterance flag to “1” in step 111, and proceeds to step 114. In a case where the determination in step 110 is negative, that is, in a case where the pitch gain is less than the first threshold Th1, the CPU 41 sets the utterance flag to “0”, that is, without changing the utterance flag, and proceeds to step 114.

In a case where the determination in step 109 is negative, that is, in a case where it is determined that the utterance flag is “1” and the previous frame corresponds to the utterance section, the CPU 41 determines whether or not the pitch gain is less than the second threshold Th2 smaller than the first threshold Th1, in step 112. In a case where the determination in step 112 is negative, the CPU 41 determines that the utterance section is continued, sets the utterance flag to “1”, that is, without changing the utterance flag, and proceeds to step 114.

In a case where the determination in step 112 is positive, that is, in a case where it is determined that the utterance section is ended, the CPU 41 sets the utterance flag to “0”, in step 113, and proceeds to step 114.

Meanwhile, in a case where the determination in step 106 is positive, that is, in a case of the synthesized voice section, the CPU 41 sets the utterance flag to “0” in step 113, and proceeds to step 114. That is, in the present embodiment, even in the case where the determination target frame corresponds to the synthesized voice section, the estimation of the background noise is performed in step 104 and step 105. Meanwhile, in the case where the determination target frame corresponds to the synthesized voice section, it is assumed that the utterance flag is set to “0” and the determination target frame is the non-utterance section without performing processes of step 107 to step 112, in step 113.

The CPU 41 determines whether or not the acoustic signal is ended, in step 114. In a case where the determination in step 114 is positive, and in a case where, for example, the acoustic signal is ended by turning off a power source of the microphone 31, the CPU 41 ends the utterance determination process. In a case where the determination in step 114 is negative, k is incremented so as to set the next frame to the determination target frame and the CPU 41 returns to step 101.

In step 106, an example in which when whether or not the determination target frame is in the synthesized voice section and the synthesized voice flag is used, but the present embodiment is not limited thereto. For example, in a case where the speaker 32 detects whether or not sound is output and the speaker 32 outputs sound, it may be determined that the determination target frame corresponding to sound being output is the synthesized voice section.

The flowchart of FIG. 8 is an example, and the order of each step may be changed.

Outline of Related Technology

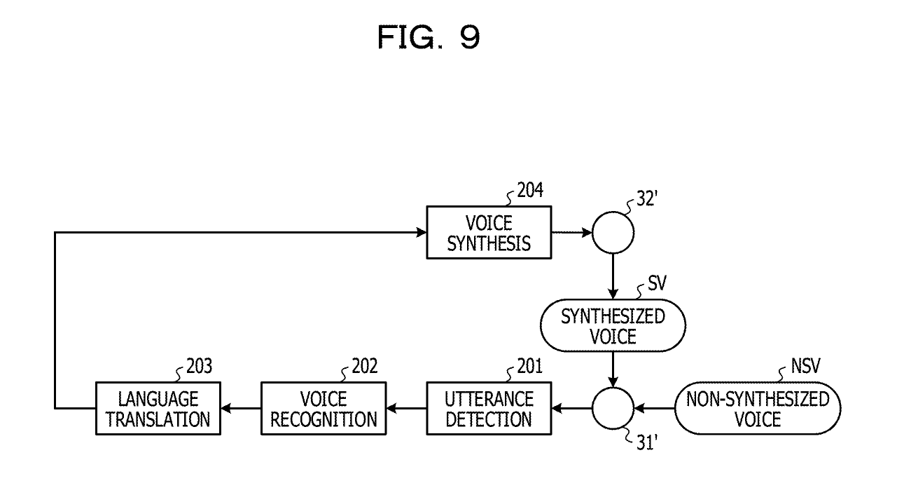

As exemplified in FIG. 9, the voice translation system of a related technology acquires sound including non-synthesized voice NSV that is user's voice by the microphone 31′, and performs the detection of the utterance section by using the acoustic signal of the acquired sound in a block 201. The voice translation system performs the voice recognition by using the detected acoustic signal of the utterance section, in a block 202, and the first language obtained by the voice recognition is translated to the second language in a block 203. The voice translation system generates the synthesized voice indicating the second language translated in a block 204, and outputs the generated synthesized voice SV through the speaker 32′.

When the output synthesized voice SV is acquired by the microphone 31′, since the acoustic features of the synthesized voice SV are similar to the acoustic features of the non-synthesized voice NSV that is user's voice, the voice translation system performs the detection of the utterance section by using the acoustic signal of the acquired voice, in a block 201. The voice translation system performs the voice recognition by using the detected acoustic signal of the utterance section, in a block 202, and translates the second language obtained by the voice recognition to the first language, in a block 203. The voice translation system generates the synthesized voice indicating the translated first language and outputs the generated synthesized voice SV through the speaker 32′, in a block 204.

That is, in a case where it is determined that the acoustic signal of sound acquired by the microphone 31′ corresponds to the sound section, the utterance is detected, and the translation from the first language to the second language and the translation from the second language to the first language are repeated indefinitely in the voice translation system performing the translation.

Utterance Detection of Related Technology

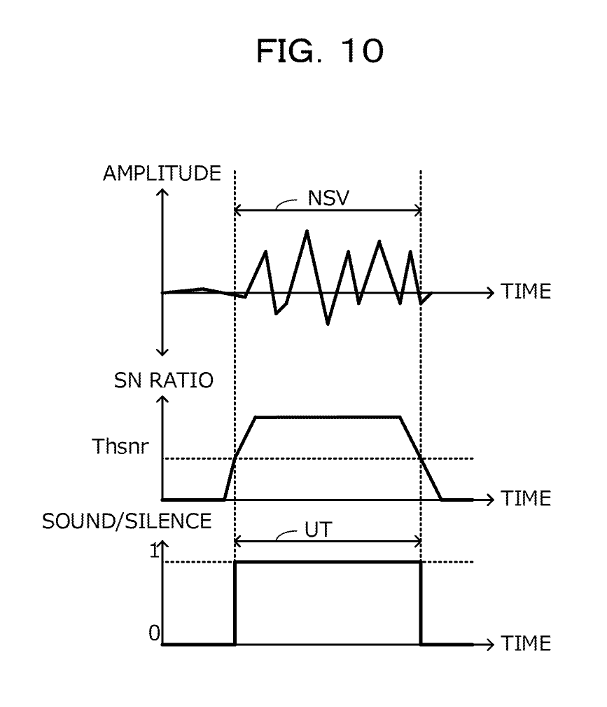

The uppermost figure of FIG. 10 exemplifies an amplitude of the acoustic signal of the non-synthesized voice NSV. The second figure from the top of FIG. 10 illustrates the SN ratio acquired by using the non-synthesized voice NSV. As described above, it is determined that a section in which the SN ratio is equal to or greater than the threshold Thsnr is the sound section. The figure at the bottom of FIG. 10 illustrates the determined result where a frame in which the SN ratio is equal to or greater than the threshold Thsnr, is set as “1” and a frame in which the SN ratio is less than the threshold Thsnr, is set as “0”. That is, the voice translation system determines that a section UT in which the determined result is “1”, is the sound section, and performs the utterance detection by using the pitch gain with the acoustic signal of the section UT.

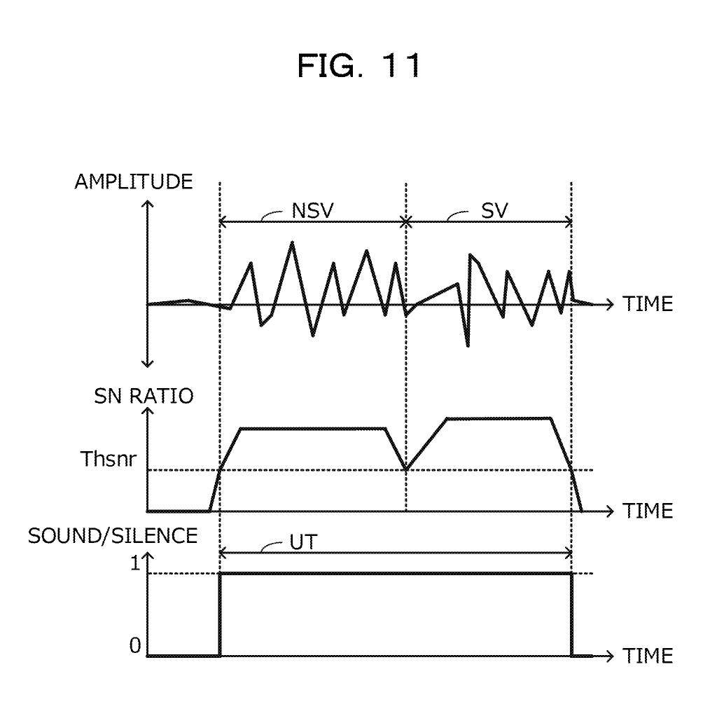

The uppermost figure of FIG. 11 exemplifies the amplitude of the acoustic signal in the non-synthesized voice NSV and the synthesized voice SV. That is, this is a case where the user speaks and the voice translation system outputs the translated result corresponding to the utterance of the user as the synthesized voice. The second figure from the top of FIG. 11 illustrates the SN ratio acquired by using the non-synthesized voice NSV and the synthesized voice SV. As described above, it is determined that the section in which the SN ratio is equal to greater than the threshold Thsnr, is the sound section.

The figure at the bottom of FIG. 11 exemplifies a determined result where a section in which the SN ratio is equal to or greater than the threshold Thsnr is set as “1” and a section in which the SN ratio is less than the threshold Thsnr is set as “0”. That is, the voice translation system determines that the section UT in which the determined result is “1”, is the sound section, and performs the utterance detection by using the pitch gain with the acoustic signal of the section UT. That is, the utterance detection is performed not only on the non-synthesized voice NSV but also on the synthesized voice SV. Since the pitch gain of the non-synthesized voice NSV and the pitch gain of the synthesized voice SV are similar to each other, not only the non-synthesized voice NSV but also the synthesized voice SV is detected as the utterance.

Background Noise of Related Technology

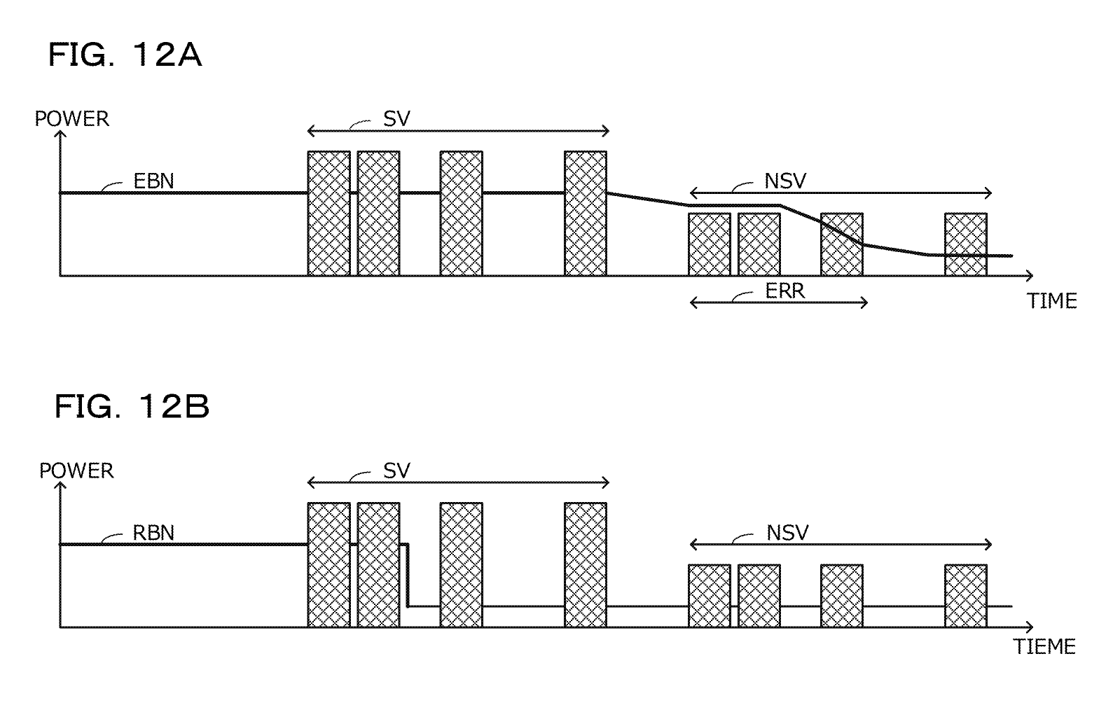

The background noise estimated in the related technology in which the utterance detection stops while the voice translation system is outputting the synthesized voice SV such that it is not determined that the synthesized voice SV is the utterance, will be described. FIG. 12A exemplifies the power of the synthesized voice SV and the non-synthesized voice NSV. Since the synthesized voice SV is output by a speaker close to the microphone of the voice translation system, the power is higher than that of the non-synthesized voice NSV which is the utterance of the user.

In FIG. 12A, the background noise estimated in the related technology is exemplified by a line EBN. In FIG. 12B, the actual background noise is illustrated by a line RBN. It is assumed that the background noise EBN before the reproduction of the synthesized voice SV of FIG. 12A is approximately the same value as that of an actual background noise RBN at the same time in FIG. 12B. While the synthesized voice SV is reproduced, that is, while the utterance detection stops, the estimation of the background noise is not performed in the related technology, even if the actual background noise RBN is changed, the estimated value of the background noise EBN is not changed.

Therefore, an error occurs between the actual background noise RBN and the estimated background noise EBN. When the reproduction of the synthesized voice SV ends, the estimation of the background noise is performed in the silence section. Here, for example, in a section ERR exemplified in FIG. 12A, by the error occurred between the actual background noise RBN and the estimated background noise EBN, it is not properly determined that the acoustic signal of the non-the synthesized voice SV corresponds to the sound section.

As exemplified by Equation (2), this is because the estimation of the background noise influences the background noise estimated by a frame positioned before a determination target frame and does not rapidly reduce an error from the actual background noise occurred while the synthesized voice SV is being reproduced.

Comparison Between Present Embodiment and Related Technology

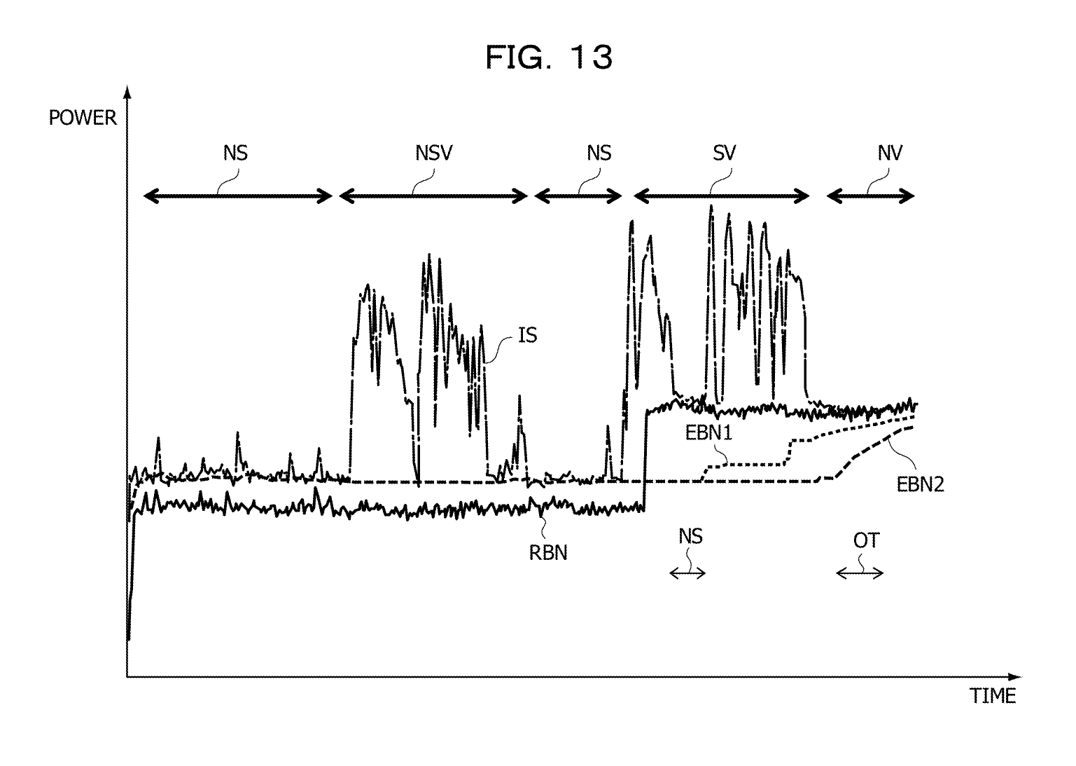

In the present embodiment, by stopping the utterance detection while the synthesized voice SV is being reproduced, the synthesized voice SV is not detected as the utterance. Meanwhile, the estimation of the background noise is performed in the silence section not only while the synthesized voice SV is being reproduced but also while the synthesized voice SV is being reproduced. FIG. 13 exemplifies power EBN1 of the background noise estimated in the present embodiment and power EBN2 of the background noise estimated in the related technology.

A line IS indicates the power of input sound over a silence section NS, a non-synthesized voice section NSV, and a synthesized voice section SV, the line RBN indicates the actual background noise. When focusing on the section OT immediately after completion of the reproduction of the synthesized voice SV, even if the synthesized voice SV is being reproduced, the background noise EBN1 of the present embodiment estimating the background noise is closer to the actual background noise RBN than the background noise EBN2 of the related technology in the silence section NS. That is, in the present embodiment, even in a section OT immediately after completion of the reproduction of the synthesized voice SV, since it is properly determined whether or not the acoustic signal corresponds to the sound section, it is properly determined whether or not the acoustic signal corresponds to the utterance section.

Specifically, for example, in a case where the actual background noise is changed from 50 dBA to 65 dBA, an error between the actual background noise of 0.1 seconds immediately after synthesized voice reproduction and the background noise estimated in the present embodiment is approximately 2 dB and approximately 10 dB in the related technology. That is, in the present embodiment, it is possible to reduce a noise estimation error by approximately 8 dB than the related technology. This means that the noise estimation error can be approximately 1/6.3 (=1/10^{8/10}) of the related art in the present embodiment.

In the present embodiment, with respect to the determination target frame among the plurality of frames including each of divided signals of the predetermined length in which the acoustic signal is divided into the plurality of signals, the signal-to-noise ratio is calculated by using the background noise estimated by using the divided signal of the frame positioned before the position of the determination target frame. It is determined that the determination target frame corresponds to the sound section based on the signal-to-noise ratio, and in a case where the determination target frame is the non-synthesized voice section, it is determined whether or not the determination target frame is a frame corresponding to the utterance section. Whether or not the determination target frame is the frame corresponding to the utterance section is determined based on the pitch gain indicating the strength of the periodicity in the divided signal of the determination target frame. The background noise is estimated based on the divided signal of the frame corresponding to the silence section of the synthesized voice section and the divided signal of the frame corresponding to the silence section of the non-synthesized voice section.

With this, in the present embodiment, while the synthesized voice is being output from the speaker, even if the detection of the utterance section is stopped, when the detection of the utterance section is restarted, it is possible to properly determine the utterance of the user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
determining, for each of a plurality of sound frames generated by dividing a sound signal data, whether each of the plurality of sound frames corresponds to an utterance section;
calculating a background noise for a target sound frame in the plurality of sound frames based on the plurality of sound frames prior to the target sound frame, the plurality of sound frames being included in a silence section that is not determined to be the utterance section;
calculating a signal-to-noise ratio by using the calculated background noise;
determining which does the target sound frame correspond to a first sound section of a first sound, or a second sound section of a second sound, the second sound being generated by transforming the first sound; and
when the target sound frame is determined to correspond to the first sound section, determining whether the target sound frame corresponds to a voice section based on a pitch gain indicating a strength of a periodicity of a sound signal of the target frame.

2. The non-transitory computer-readable storage medium according to claim 1, wherein
the plurality of sound frames includes both one or more sound frames corresponding to the first sound section and one or more sound frames corresponding to the second sound section.

3. The non-transitory computer-readable storage medium according to claim 1,
the determining whether the target sound frame corresponds to the voice section determines that the target sound frame does not correspond to the voice section when the target sound frame is determined to correspond to the second sound section.

4. The non-transitory computer-readable storage medium according to claim 1, wherein
in the determining whether the target sound frame corresponds to the voice section, the target sound frame is determined to correspond to a start of the voice section when the pitch gain is equal to or greater than a first threshold and when the a previous sound frame of the target sound frame does not correspond to the voice section; and wherein
in the determining whether the target sound frame corresponds to the voice section, the target sound frame is determined to correspond to an end of the voice section when the pitch gain is equal to or greater than a second threshold lower than the first threshold and when previous sound frame of the target sound frame corresponds to the voice section.

5. An voice section determination method executed by a computer, the utterance determination method comprising:
determining, for each of a plurality of sound frames generated by dividing a sound signal data, whether each of the plurality of sound frames corresponds to an utterance section;
calculating a background noise for a target sound frame in the plurality of sound frames based on the plurality of sound frames prior to the target sound frame, the plurality of sound frames being included in a silence section that is not determined to be the utterance section;
calculating a signal-to-noise ratio by using the calculated background noise;
determining which does the target sound frame correspond to a first sound section of a first sound, or a second sound section of a second sound, the second sound being generated by transforming the first sound; and
when the target sound frame is determined to correspond to the first sound section, determining whether the target sound frame corresponds to a voice section based on a pitch gain indicating a strength of a periodicity of a sound signal of the target frame.

6. A voice section determination device comprising:
a memory; and
a processor coupled to the memory and the processor configured to execute a process, the process including:
determining, for each of a plurality of sound frames generated by dividing a sound signal data, whether each of the plurality of sound frames corresponds to an utterance section;
calculating a background noise for a target sound frame in the plurality of sound frames based on the plurality of sound frames prior to the target sound frame, the plurality of sound frames being included in a silence section that is not determined to be the utterance section;
calculating a signal-to-noise ratio by using the calculated background noise;
determining which does the target sound frame correspond to a first sound section of a first sound, or a second sound section of a second sound, the second sound being generated by transforming the first sound; and
when the target sound frame is determined to correspond to the first sound section, determining whether the target sound frame corresponds to a voice section based on a pitch gain indicating a strength of a periodicity of a sound signal of the target frame.
